(19) United States
(12) Patent Application Publication
(10) Pub. No.: US 2025/0061913 A1
(43) Pub. Date: Feb. 20, 2025

(54) SIGNAL PROCESSING APPARATUS, SIGNAL PROCESSING METHOD, AND PROGRAM

(71) Applicant: NIPPON TELEGRAPH AND TELEPHONE CORPORATION, Tokyo (JP)

(72) Inventors: Rintaro IKESHITA, Tokyo (JP); Tomohiro NAKATANI, Tokyo (JP)

(73) Assignee: NIPPON TELEGRAPH AND TELEPHONE CORPORATION, Tokyo (JP)

(21) Appl. No.: 18/722,169

(22) PCT Filed: Dec. 23, 2021
(86) PCT No.: PCT/JP2021/047856

§ 371 Date: Jun. 20, 2024

(51) Int. Cl. G10L 21/0308; G10L 21/028

(52) U.S. Cl. CPC G10L 21/0308; G10L 21/028

(57) ABSTRACT

A signal processing device includes: a separation signal updating unit that solves a minimization problem of an upper bound function related to a separation matrix W in a majorization-minimization algorithm for a signal source separation technique (independent vector analysis, IVA) by dividing a mixed matrix A into sub matrixes A¹, . . . , A^{L} having d columns (d is an integer equal to or larger than 2) and updating sets (W, A^{l}) (l=1, . . . , L) of the separation matrix W and the sub matrixes A¹, . . . , A^{L} one by one and updates a separation signal Y according to updating of the separation matrix W.

### TECHNICAL FIELD

The present invention relates to a signal processing device, a signal processing method, and a program.

### BACKGROUND ART

A signal source separation technique (or a sound source separation technique) for estimating a source signal before mixing from a mixed signal which is observed is a technique that is widely used for preprocessing of speech recognition and the like. As a method of performing signal source separation using a plurality of sensors, independent component analysis (ICA, Non Patent Literature 1) and independent vector analysis (IVA, Non Patent Literature 2) are known.

As an optimization algorithm for the ICA and the IVA, an algorithm called iterative projection (IP) has been developed. As the IP, IP1 (Non Patent Literature 2) and IP2 (Non Patent Literature 3) have been developed.

As another optimization algorithm for the ICA and the IVA, an algorithm called iterative source steering (ISS, Non Patent Literature 4) has also been developed. The ISS is referred to as ISS₁ in the present specification.

### CITATION LIST

### Non Patent Literature

Non Patent Literature 1: P. Comon, “Independent component analysis, a new concept?” Signal processing 36.3 (1994), 287-314.
Non Patent Literature 2: N. Ono, “Stable and fast update rules for independent vector analysis based on auxiliary function technique,” IEEE Workshop on Applications of Signal Processing to Audio and Acoustics (WASPAA), 2011, pp. 189-192.
Non Patent Literature 3: Nobutaka Ono, “San ongen ijo ni taisuru dokuritsu seibun bunseki dokuritsu bekutoru bunseki dokuritsu tei ranku gyoretsu bunseki no kosoku kaiho (in Japanese) (High-speed solution of independent component analysis, independent vector analysis, and independent low-rank matrix analysis for three or more sound sources)”, Proceedings of Acoustical Society of Japan, March 2018.
Non Patent Literature 4: R. Scheibler and N. Ono, “Fast and Stable Blind Source Separation with Rank-1 Updates,” IEEE International Conference on Acoustics, Speech and Signal Processing (ICASSP), 2020, pp. 236-240.

### SUMMARY OF INVENTION

### Technical Problem

The IP2 corresponding to an extension of the IP1 has fast convergence, but has a problem that a calculation amount per iteration is large. On the other hand, the ISS₁ has a small calculation amount per iteration, but has a problem that convergence is slow.

Therefore, an object of the present invention is to provide a signal processing device that achieves both fast convergence of the IP2 and a small calculation amount of the ISS₁.

### Solution to Problem

The signal processing device of the present invention includes a separation signal updating unit.

The separation signal updating unit solves a minimization problem of an upper bound function related to a separation matrix W in a majorization-minimization algorithm for a signal source separation technique (independent vector analysis, IVA) by dividing a mixed matrix A into sub matrixes A¹, . . . , A^{L} having d columns (d is an integer equal to or larger than 2) and updating sets (W, A^{l) (l}=1, . . . , L) of the separation matrix W and the sub matrixes A¹, . . . , A^{L} one by one, and updates a separation signal Y according to updating of the separation matrix W.

### Advantageous Effects of Invention

According to the signal processing device of the present invention, it is possible to achieve both fast convergence of the IP2 and a small calculation amount of the ISS₁.

### BRIEF DESCRIPTION OF DRAWINGS

FIG. 1 is a block diagram illustrating a functional configuration of a signal processing device of Example 1.

FIG. 2 is a flowchart illustrating an operation of the signal processing device of Example 1.

FIG. 3 is a graph showing a result of an experiment for comparing a method in the related art and a method of the present invention.

FIG. 4 is a diagram illustrating a functional configuration example of a computer.

### DESCRIPTION OF EMBODIMENTS

Hereinafter, an embodiment of the present invention will be described in detail. Note that components having the same functions are denoted by the same reference numerals, and redundant description will be omitted.

### Independent Vector Analysis (IVA)

A problem of signal source separation handled in the present invention is defined as follows. It is assumed that X is an observation signal and is a product of a mixed matrix A and a matrix S in which source signals are arranged (expression (1)).

$$\begin{matrix}[ Math . 1 ] & \\ {X}^{[ k ]} = {A}^{[ k ]} {S}^{[ k ]} ∈ {ℂ}^{m \times n} , k = 1 , … , K & ( 1 )\end{matrix}$$

Assuming that K≥1, m∈N is the number of sensors, n∈N is the number of sample points, X^{[k]}∈C^{m×n} is an observation signal, S^{[k]}∈C^{m×n} is original m source signals, and A^{[k]}∈GL(m) is a mixed matrix.

In order to estimate the source signal S, instead of the mixed matrix A, a separation matrix W(=A⁻¹) that is an inverse matrix of A may be estimated. A separation result is Y=WX. The separation matrix W^{[k]}∈GL(m), k=1, . . . , K is defined by the following expression (2).

$$\begin{matrix}[ Math . 2 ] & \\ {W}^{[ k ]} {A}^{[ k ]} = {D}^{[ k ]} Π , k = 1 , … , K & ( 2 )\end{matrix}$$

D^{[k]} and Π are a certain diagonal matrix and a certain permutation matrix each of which has a size of m×m, and respectively correspond to a scale and an ambiguity of a permutation of the separation signal represented as follows.

$$\begin{matrix}\text{[Math . 3]} & \\ {Y}^{[ k ]} {=}^{△} {W}^{[ k ]} {X}^{[ k ]} & \end{matrix}$$

A model of the signal source separation technique IVA handled in the present invention is defined as follows. In the IVA, it is assumed that a multivariate vector which has a length K and is given by the following expression (3) follows a probability density function having a correlation of a second order or higher.

$$\begin{matrix}[ Math . 4 ] & \\ {y}_{i j} {=}^{△} {[ {Y}_{ij}^{[ 1 ]} , … , {Y}_{ij}^{[ K ]} ]}^{⊤} ∈ {ℂ}^{K} & ( 3 )\end{matrix}$$

It is assumed that probability variables {yᵢⱼ}ᵢⱼ are independent of each other. In this model, as a cost function for optimizing the separation matrix represented as follows,

$$\begin{matrix}\text{[Math . 5]} & \\ W {=}^{△} {( {W}^{[ k ]} )}_{k = 1}^{K} & \end{matrix}$$

a negative log likelihood represented by the following expression (4) can be used.

$$\begin{matrix}[ Math . 6 ] & \\ {ℒ}_{1} ( W ) {=}^{△} \frac{1}{n} log p ( {X}^{[ 1 ]} , … , {X}^{[ K ]} ; W ) = - \frac{1}{n} {\sum }_{i = 1}^{m} {\sum }_{j = 1}^{n} log p ( {y}_{i j} ) - {\sum }_{k = 1}^{K} log \vert det {W}^{[ k ]} {\vert}^{2} & ( 4 )\end{matrix}$$

The optimization of the separation matrix W is performed so as to minimize the negative log likelihood represented by the expression (4). Both the algorithms IP1, IP2, and ISS₁ in the related art and an algorithm ISS₂ belonging to the present invention are iteration algorithms for solving “optimization problem of minimizing the expression (4) for W”.

The algorithms IP1, IP2, and ISS₁ in the related art and the algorithm ISS₂ belonging to the present invention are algorithms belonging to a framework called a majorization-minimization algorithm (MM algorithm). The MM algorithm for the IVA is as follows.

### MM Algorithm for IVA

The MM algorithm for the ICA has been proposed in referenced Non Patent Literatures 1 to 3.
(Referenced Non Patent Literature 1: N. Ono and S. Miyabe, “Auxiliary-function-based independent component analysis for super-Gaussian sources,” in Proc. LVA/ICA, 2010, pp. 165-172.)
(Referenced Non Patent Literature 2: P. Ablin, A. Gramfort, J.-F. Cardoso, and F. Bach, “Stochastic algorithms with descent guarantees for ICA,” in Proc. AISTATS, 2019, pp. 1564-1573.)
(Referenced Non Patent Literature 3: N. Ono, “Stable and fast update rules for independent vector analysis based on auxiliary function technique,” in Proc. WASPAA, 2011, pp. 189-192.)

Here, assuming that p(y) is a symmetric probability density function,

$$G : {ℝ}_{\geq 0} \to ℝ \qquad [ Math . 7 ]$$

is defined by the following expression.

$$G ( {‖ y ‖}_{2} ) {=}^{Δ} - log p ( y ) with {‖ y ‖}_{2} {=}^{Δ} \sqrt{{y}^{H} y} \qquad [ Math . 8 ]$$

When G′(r)/r monotonically decreases at r∈(0, ∞)=R_{>0}, p(y) is said to be a super-Gaussian distribution. Here, G′ is a first derivative function of G (refer to referenced Non Patent Literatures 1, 2, 4 (pp. 60-61), and 5).
(Referenced Non Patent Literature 4: A. Benveniste, M. Metivier, and P. Priouret, Adaptive algorithms and stochastic approximations, 1st ed. Springer Science, 1990, vol. 22.)
(Referenced Non Patent Literature 5: J. Palmer, D. Wipf, K. Kreutz-Delgado, and B. Rao, “Variational EM algorithms for non-Gaussian latent variable models,” in Proc. NIPS, vol. 18, 2005, pp. 1059-1066.)

For example, a generalized Gaussian distribution (GGD) given by the expression (5) is a super-Gaussian distribution.

$$\begin{matrix}[ Math . 9 ] & \\ G ( {‖ y ‖}_{2} ) = {‖ y ‖}_{2}^{β} + const . , 0 < β < 2 & ( 5 )\end{matrix}$$

The GGD when β=1 is a Laplace distribution. For G(r) that is a super-Gaussian distribution, in referenced Non Patent Literatures 1, 2, and 5, it is known that there is a function φ: R_{≥0}→R satisfying the expression (6).

$$\begin{matrix}[ Math . 10 ] & \\ G ( r ) = {min}_{λ \geq 0} \{ \frac{λ {r}^{2}}{2} + φ ( λ ) \} & ( 6 )\end{matrix}$$

The right side of the expression (6) takes a minimum value when λ=G′(r)/r. When the expression (6) is used for −log p(yᵢⱼ)=G(∥yᵢⱼ∥₂) in the expression (4), for L₁(W), a surrogate function (or upper bound function) denoted as L₂(W, Λ) is obtained.

$$\begin{matrix}[ Math . 11 ] & \\ {ℒ}_{1} ( W ) = {min}_{Λ} \{ {ℒ}_{2} ( W , Λ ) \vert Λ ∈ {ℝ}_{\geq 0}^{m \times n} \} & ( 7 )\end{matrix}$$

$${ℒ}_{2} ( W , Λ ) {=}^{Δ} {\sum }_{k = 1}^{K} {ℒ}_{3}^{[ k ]} ( {W}^{[ k ]} , Λ ) + {\sum }_{i = 1}^{m} {\sum }_{j = 1}^{n} \frac{{φ}_{ij} ( {Λ}_{ij} )}{n} \qquad ( 8 )$$

$${ℒ}_{3}^{[ k ]} ( {W}^{[ k ]} , Λ ) {=}^{Δ} {\sum }_{i = 1}^{m} {( {w}_{i}^{[ k ]} )}^{H} {V}_{i}^{[ k ]} {w}_{i}^{[ k ]} - log {\vert det {W}^{[ k ]} \vert}^{2} \qquad ( 9 )$$

$${w}_{i}^{[ k ]} {=}^{Δ} {( {W}_{i ,}^{[ k ]} )}^{H} ( ⇔ {W}^{[ k ]} = {[ {w}_{1}^{[ k ]} , … , {w}_{m}^{[ k ]} ]}^{H} )$$

$${V}_{i}^{[ k ]} {=}^{Δ} \frac{1}{2 n} {X}^{[ k ]} diag ( {Λ}_{i ,} ) {( {X}^{[ k ]} )}^{H} ∈ {S}_{+}^{m} \qquad ( 10 )$$

Under the surrogate function (expression (8)), the MM algorithm for the IVA (referenced Non Patent Literature 3) alternately updates Λ and W based on the expression (11) and the expression (12).

$$\begin{matrix}[ Math . 12 ] & \\ Λ ∈ {arg min}_{Λ} \{ {ℒ}_{2} ( W , Λ ) \vert Λ ∈ {ℝ}_{\geq 0}^{m \times n} \} & ( 11 )\end{matrix}$$

$${W}^{[ k ]} ∈ {arg min}_{{W}^{[ k ]} ∈ GL ( m )} {ℒ}_{3}^{[ k ]} ( {W}^{[ k ]} ) , k = 1 , … , K \qquad ( 12 )$$

Hereinafter, when discussing L₃^{[k]}, the factor Λ will be omitted. From the expression (7), the expression (11) is solved as the following expression (13).

$$\begin{matrix}[ Math . 13 ] & \\ {Λ}_{ij} ← \frac{{G}^{′} ( {‖ {y}_{ij} ‖}_{2} )}{{‖ {y}_{ij} ‖}_{2}} ∈ {ℝ}_{> 0} & ( 13 )\end{matrix}$$

For the expression (12), in a case of m=2, an analytical solution is obtained (referenced Non Patent Literatures 6 and 7).
(Referenced Non Patent Literature 6: “Determinant maximization of a nonsymmetric matrix with quadratic constraints,” SIAM J. Optim., vol. 17, no. 4, pp. 997-1014, 2007.)
(Referenced Non Patent Literature 7: N. Ono, “Fast stereo independent vector analysis and its implementation on mobile phone,” in Proc. IWAENC, 2012, pp. 1-4.)

Here, in a case of m≥3, an algorithm for obtaining a global optimal solution of the expression (12) is not found. For this reason, as a block coordinate descent method (BCD) for solving the expression (12), the IP1, the IP2, and the ISS₁ have been developed. These algorithms are referred to as MM+BCD. In the present invention, as a new MM+BCD, ISS_{d} is disclosed.

Hereinafter, in order to simplify notations, the upper right index [k] will be omitted when describing the expression (12).

### MM+BCD Algorithm Disclosed in Present Specification

A difference between the algorithms IP1, IP2, and ISS₁ in the related art and the algorithm ISS_{d} disclosed in the present specification is a difference in the method of solving the “optimization problem (expression (12)) related to the separation matrix W of the upper bound function (expression (9))” in the MM algorithm.

The ISS (referenced Non Patent Literature 8, ISS₁) in the related art is an algorithm that updates A column by column in each iteration.
(Referenced Non Patent Literature 8: R. Scheibler and N. Ono, “Fast and stable blind source separation with rank-1 updates,” in Proc. ICASSP, 2020, pp. 236-240.)

The ISS₂ disclosed in this specification is an algorithm that updates A by two columns in each iteration. In order to extend the ISS₁ to the ISS₂, for a certain number d≥1, a unified method for developing an ISS_{d} that updates A by d columns is disclosed.

### Definition of ISS_{d}

d is a divisor of m. It is considered that A is divided into L sub matrixes A¹, . . . , A^{L} having d columns.

$$\begin{matrix}[ Math . 14 ] & \\ A = [ {\underbrace{{A}^{1}}}_{d} \vert … \vert {\underbrace{{A}^{L}}}_{d} ] ∈ {ℂ}^{m \times n} & ( 14 )\end{matrix}$$

The ISS_{d} is an MM+BCD method of updating (W, A^{l}) based on the expression (16) and updating the expression (15) based on the expression (11) for each l=1, . . . , L. In a case of d=1, the definition of the ISS₁ of the present invention is consistent with the ISS₁ in the related art (referenced Non Patent Literature 8).

$$\begin{matrix}[ Math . 15 ] & \\ Λ \to ( W , {A}^{1} ) \to ( W , {A}^{2} ) \to … \to ( W , {A}^{L} ) & ( 15 )\end{matrix}$$

$$( W , {A}^{ℓ} ) ∈ {arg min}_{( W , {A}^{ℓ} )} \{ {ℒ}_{3} ( W ) \vert WA = {I}_{m} \} \qquad ( 16 )$$

### Formulation as Multiplicative Updating (MU) Algorithm for ISS_{d}

The ISS_{d} can be described as a multiplicative updating algorithm for W (or Y=WX). When l=1, updating (W, A¹) based on the expression (16) is equivalent to the next multiplicative updating related to W (and A).

$$\begin{matrix}[ Math . 16 ] & \\ T ∈ {arg min}_{T} \{ {ℒ}_{3} ( TW ) \vert T ∈ {𝒟}_{{ISS}_{d}} \} & ( 17 )\end{matrix}$$

$$W ← TW ( and A ← {AT}^{- 1} ) \qquad ( 18 )$$

Here, D in the expression (17) is defined as follows.

$${𝒟}_{{ISS}_{d}} {=}^{Δ} \{ [ \begin{matrix}P & {O}_{d , m - d} \\ Q & {I}_{m - d}\end{matrix} ] \vert P ∈ GL ( d ) , Q ∈ {ℂ}^{( m - d ) \times d} \} \qquad [ Math . 17 ]$$

Also for general l=1, . . . , L, by updating (W, A¹) based on the expression (16) as follows, multiplicative updating that is expressed by the expression (17) and the expression (18) can be realized. For the multiplicative updating, a permutation matrix defined by

$$\begin{matrix}[ Math . 18 ] & \\ {\prod }_{d} = [ \begin{matrix} & \begin{matrix}{I}_{d} & & \\ & ⋱ & \\ & & {I}_{d}\end{matrix} \\ {I}_{d} & \end{matrix} ] ∈ {ℂ}^{m \times n} & ( 19 )\end{matrix}$$

is prepared. By updating the separation matrix W, the mixed matrix A, the separation signal Y, and auxiliary variable in advance according to

$$\begin{matrix}[ Math . 19 ] & \\ W ← {\prod }_{d}^{ℓ - 1} W , Y ← {\prod }_{d}^{ℓ - 1} Y , Λ ← {\prod }_{d}^{ℓ - 1} Λ , & ( 20 )\end{matrix}$$

$$A ← {A ( {\prod }_{d}^{ℓ - 1} )}^{T} = [ {A}^{ℓ} , … , {A}^{L} , {A}^{1} , … , {A}^{ℓ - 1} ] \qquad ( 21 )$$

using the permutation matrix, updating (W, A^{l}) based on the expression (16) is equivalent to updating (W, A^{l}) based on the multiplicative updating expression represented by the expression (17) and the expression (18).

### Analytical Updating Expression of ISS₂

Since the problem (17) can be analytically solved when d=2 is satisfied, the ISS₂ disclosed in the present invention is an algorithm described using only the following analytical updating expression.

[Math. 20]
Algorithm 1: IVA by ISS₂

Input: X^{[k]} ∈ [symbol] ^{m×n} (k = 1, . . . , K)
Output: Y^{[k]} ∈ [symbol] ^{m×n} (k = 1, . . . , K)

| 1 | Initialize W^{[k]} as a whitening matrix for k = 1, . . . , K. | | | | |
|---|---|---|---|---|---|
| 2 | Y^{[k]} ← W^{[k]} X^{[k]} for each k = 1, . . . , K. | | | | |
| 3 | for t = 1, 2, . . . , max. number of MM iterations do | | | | |
| 4 | \| | Λᵢⱼ & G′(∥yᵢⱼ∥₂ + [symbol] ) / (∥yᵢⱼ∥₂ + [symbol] ), where | | | |
| | \| | [symbol] = 10⁻¹⁰ is added to improve numerical stability. | | | |
| 5 | \| | $for ℓ = 1 , … , \frac{m}{2} do$ | | | |
| 6 | \| | \| | for k = 1, . . . , K do | | |
| 7 | \| | \| | \| | for i = 3, . . . , m do | |
| 8 | \| | \| | \| | \| | ${G}_{i}^{[ k ]} {=}^{△} \frac{1}{2 n} {Y}_{1 : 2}^{[ k ]} diag ( {Λ}_{i} , ) {( {Y}_{1 : 2}^{[ k ]} , )}^{H}$ |
| 9 | \| | \| | \| | \| | ${g}_{i}^{( k )} {=}^{△} \frac{1}{2 n} {Y}_{1 : 2}^{[ k ]} diag ( {Λ}_{i} , ) {( {Y}_{i ,}^{[ k ]} )}^{H}$ |
| 10 | \| | \| | \| | └ | Y_{i,•}^{[k]} ← Y_{i,•}^{[k]} − (gᵢ^{[k]})^{H}(Gᵢ^{[k]})⁻¹Y_{1:2,•}^{[k]} |
| 11 | \| | \| | \| | for i = 1, 2 do | |
| 12 | \| | \| | \| | └ | ${G}_{i}^{[ k ]} {=}^{△} \frac{1}{2 n} {Y}_{1 : 2}^{[ k ]} diag ( {Λ}_{i} , ) {( {Y}_{1 : 2}^{[ k ]} , )}^{H}$ |

| | | | | |
|---|---|---|---|---|
| 13 | \| | \| | \| | Update P^{[k]} ∈ [symbol] ^{2×2} using (28)-(30). |
| 14 | \| | \| | \| | Y_{1:2,•}^{[k]} ← P^{[k]}Y_{1:2,•}^{[k]} ∈ [symbol] ^{2×n} |
| 15 | \| | \| | └ | Y^{[k]} ← Π₂Y^{[k]} / / permute rows |

| | | | |
|---|---|---|---|
| 16 | \| | └ | Λ ← Π₂Λ // permute rows |

└

$$\begin{matrix}[ Math . 21 ] & \\ H = {G}_{1}^{- 1} {G}_{2} ∈ {2 \times 2}^{} & ( 22 )\end{matrix}$$

$${θ}_{1} = \frac{Tr ( H ) + \sqrt{{( Tr ( H ) )}^{2} - 4 det ( H )}}{2} , {θ}_{2} = \frac{det H}{{θ}_{1}}$$

$${u}_{1} = [ \begin{matrix}{H}_{22} - {θ}_{1} \\ - {H}_{21}\end{matrix} ] , {u}_{2} = [ \begin{matrix}- {H}_{12} \\ {H}_{11} - {θ}_{2}\end{matrix} ] ∈ {2 \times 1}^{} \qquad ( 23 )$$

$${p}_{i} = \frac{{u}_{i}}{{( {u}_{i}^{H} {V}_{i} {u}_{i} )}^{\frac{1}{2}}} ∈ {2 \times 1}^{} , i = 1 , 2 \qquad ( 24 )$$

### Example 1

Example 1 to be described below discloses a signal processing device 1 that implements an algorithm ISS_{d} (d is a certain natural number) for solving the optimization problem (expression (7)) related to the separation matrix W by the method described in <Definition of ISS_{d}>. As described above, the ISS_{d} is an extension of the technique ISS₁ in the related art.

Specifically, as shown in the expression (15), the ISS_{d} is an algorithm that updates sets of (W, A^{l}) one by one according to the optimization problem (expression (16)). Since the update rule (expression (16)) is the same as the update rule (expression (17) and expression (18)), the (W, A^{l}) is updated according to the update rule (expression (17) and expression (18)). A policy of updating the separation matrix W by updating a part of the mixed matrix A is a feature of the ISS.

As described above, the algorithm ISS_{d} when d=1 is satisfied matches the ISS₁ in the related art, and the algorithm ISS_{d} when d=2 is satisfied corresponds to the ISS₂ disclosed in the present example.

### Signal Processing Device 1

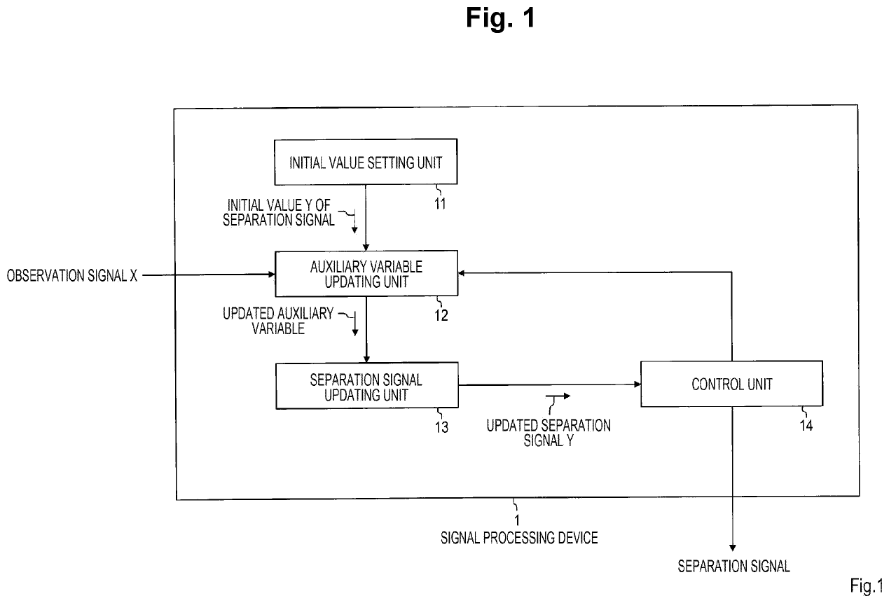

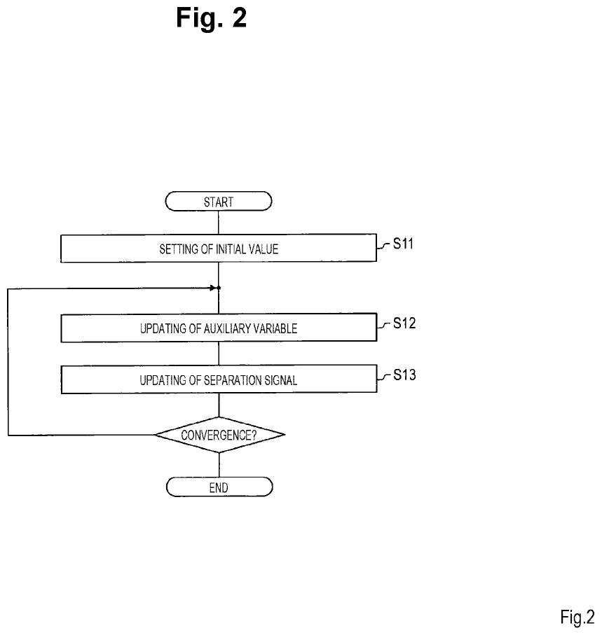

Hereinafter, a functional configuration of a signal processing device 1 according to the present example will be described with reference to FIG. 1. As illustrated in FIG. 1, the signal processing device 1 according to the present example includes an initial value setting unit 11, an auxiliary variable updating unit 12, a separation signal updating unit 13, and a control unit 14. Hereinafter, an operation of the signal processing device 1 will be described with reference to FIG. 2.

### Initial Value Setting Unit 11

The initial value setting unit 11 sets an appropriate initial value to the separation matrix W, and calculates an initial value Y of the separation signal by Y=WX (S11).

### Auxiliary Variable Updating Unit 12

The auxiliary variable updating unit 12 repeatedly updates the auxiliary variable Λ according to a control of the control unit 14 (S12).

### Separation Signal Updating Unit 13

The separation signal updating unit 13 repeatedly updates the separation signal Y according to a control of the control unit 14 (S13). Specifically, in the optimization problem (expression (12)) related to the separation matrix W of the upper bound function in the majorization-minimization algorithm for the signal source separation technique IVA (independent vector analysis), the separation signal updating unit 13 repeatedly updates the separation signal Y (=WX) by dividing the mixed matrix A into the sub matrixes A¹, . . . , and A^{L} having d (d is an integer equal to or larger than 2) columns (expression (15)) and repeatedly updating sets of (W, A^{l}) (l=1, . . . , L) of the separation matrix W and the sub matrixes A¹, . . . , A^{L} one by one according to the minimization problem (expression (16)) related to W of the upper bound function (S13).

Since updating the separation matrix W is equivalent to updating the separation signal Y, it is sufficient to update only the separation signal Y without updating the separation matrix W.

### Control Unit 14

The control unit 14 controls the auxiliary variable updating unit 12 and the separation signal updating unit 13 to alternately and repeatedly execute processing until a predetermined condition is satisfied.

As the predetermined condition, a condition until a predetermined number of repetitions is reached or a condition until an update amount of each parameter becomes equal to or lower than a predetermined threshold value may be used.

### Experiment Result

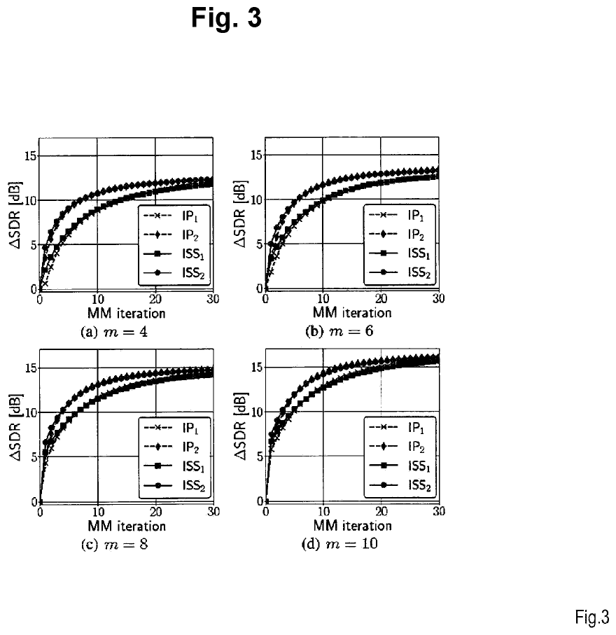

FIG. 3 illustrates SDR improvements obtained in each method. It can be seen that convergence of the proposed ISS₂ is much faster than convergence of the ISS₁ and the IP1 and is comparable to convergence of IP2 (note that SDR curves of IP2 and ISS₂ almost overlap). This is clear evidence of effectiveness of approach of the present invention.

### Supplement

The device according to the present invention as a single hardware entity includes, for example, an input unit to which a keyboard or the like can be connected, an output unit to which a liquid crystal display or the like can be connected, a communication unit to which a communication device (for example, a communication cable) that can communicate with the outside of the hardware entity can be connected, a central processing unit (CPU in which a cache memory, a register, or the like may be included), a RAM or a ROM as a memory, an external storage device as a hard disk, and a bus that connects the input unit, the output unit, the communication unit, the CPU, the RAM, the ROM, and the external storage device such that data can be exchanged therebetween. A device (drive) or the like that can write and read data in and from a recording medium such as a CD-ROM may be provided in the hardware entity as necessary. Examples of a physical entity including such a hardware resource include a general-purpose computer.

The external storage device of the hardware entity stores a program required for implementing the above-described functions, data required for processing of the program, and the like (the program may be stored, for example, in a ROM as a read-only storage device instead of the external storage device). Further, data and the like obtained by processing of the program are appropriately stored in the RAM, the external storage device, or the like.

In the hardware entity, each program stored in the external storage device (or ROM or the like) and data required for processing of each program are read into a memory as necessary and are appropriately interpreted and processed by the CPU. Thereby, the CPU implements a predetermined function (each component represented as . . . unit, . . . means, or the like).

The present invention is not limited to the above-described embodiment and can be appropriately modified without departing from the gist of the present invention. Moreover, the processing described in the above embodiment may be executed not only in time-series according to the described order, but also in parallel or individually according to the processing capability of the device that executes the processing or as necessary.

As described above, in a case where the processing function of the hardware entity (the device according to the present invention) described in the above embodiment is implemented by a computer, processing content of the function of the hardware entity is described by a program. In addition, the computer executes the program, and thus, the processing functions of the hardware entity are implemented on the computer.

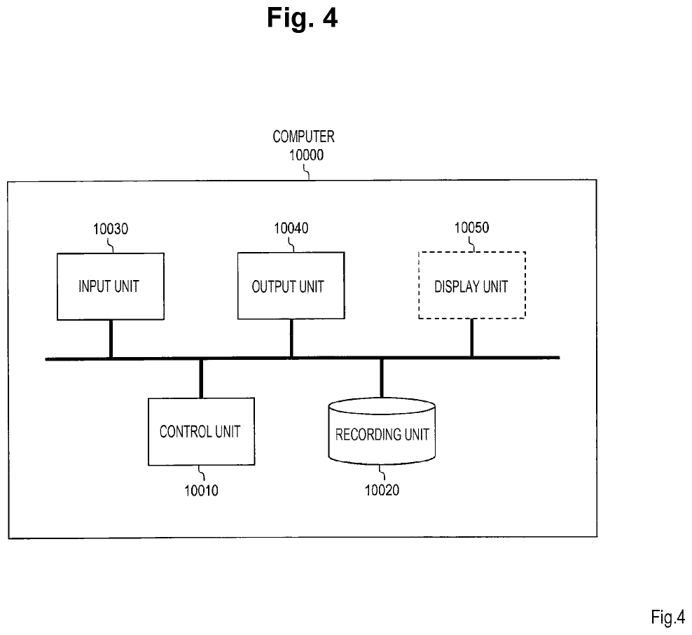

The above-described various types of processing can be performed by causing a recording unit 10020 of a computer 10000 illustrated in FIG. 4 to read a program for executing each step of the method and causing a control unit 10010, an input unit 10030, an output unit 10040, and the like to operate.

The program in which the processing content is described can be recorded in a computer-readable recording medium. The computer-readable recording medium may be, for example, any recording medium such as a magnetic recording device, an optical disk, a magneto-optical recording medium, or a semiconductor memory. Specifically, for example, a hard disk device, a flexible disk, a magnetic tape, or the like can be used as the magnetic recording device, a digital versatile disc (DVD), a DVD random access memory (DVD-RAM), a compact disc read only memory (CD-ROM), a CD recordable/rewritable (CD-R/RW), or the like can be used as the optical disc, a magneto-optical disc (MO) or the like can be used as the magneto-optical recording medium, and an electrically erasable and programmable-read only memory (EEP-ROM) or the like can be used as the semiconductor memory.

In addition, the program is distributed by, for example, selling, transferring, or renting a portable recording medium such as a DVD or a CD-ROM in which the program is recorded. Further, a configuration in which the program is stored in a storage device of a server computer and the program is distributed by transferring the program from the server computer to other computers via a network may also be employed.

For example, a computer that executes such a program first temporarily stores a program recorded on a portable recording medium or a program transferred from the server computer in a storage device of the computer. In addition, when executing processing, the computer reads the program stored in the recording medium of the computer and executes the processing according to the read program. Further, in other modes of execution of the program, the computer may read the program directly from a portable recording medium and execute processing according to the program, or alternatively, the computer may sequentially execute processing according to a received program every time a program is transferred from the server computer to the computer. In addition, the above-described processing may be executed by a so-called application service provider (ASP) type service that implements a processing function only by an execution instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

In addition, although the hardware entity is configured by a predetermined program being executed on a computer in this mode, at least some of the processing contents may be implemented by hardware.

1. A signal processing device comprising:
a separation signal updating unit that solves a minimization problem of an upper bound function related to a separation matrix W in a majorization-minimization algorithm for a signal source separation technique (independent vector analysis, IVA) by dividing a mixed matrix A into sub matrixes A¹, . . . , A^{L} having d columns (d is an integer equal to or larger than 2) and updating sets (W, A^{l}) (l=1, . . . , L) of the separation matrix W and the sub matrixes A¹, . . . , A^{L} one by one and updates a separation signal Y according to updating of the separation matrix W.

2. The signal processing device according to claim 1,
wherein d=2 is satisfied.

3. A signal processing method executed by a signal processing device, the signal processing method comprising:
a step of solving a minimization problem of an upper bound function related to a separation matrix W in a majorization-minimization algorithm for a signal source separation technique (independent vector analysis, IVA) by dividing a mixed matrix A into sub matrixes A¹, . . . , A^{L} having d columns (d is an integer equal to or larger than 2) and updating sets (W, A^{l}) (l=1, . . . , L) of the separation matrix W and the sub matrixes A¹, . . . , A^{L} one by one and updating a separation signal Y according to updating of the separation matrix W.

4. (canceled)

5. The signal processing method according to claim 3,
wherein d=2 is satisfied.

6. A computer-readable non-transitory recording medium storing computer-executable program instructions that when executed by a processor cause a computer to execute a program for causing a computer to function as the signal processing device comprising:
a separation signal updating unit that solves a minimization problem of an upper bound function related to a separation matrix W in a majorization-minimization algorithm for a signal source separation technique (independent vector analysis, IVA) by dividing a mixed matrix A into sub matrixes A¹, . . . , A^{L} having d columns (d is an integer equal to or larger than 2) and updating sets (W, A^{l}) (l=1, . . . , L) of the separation matrix W and the sub matrixes A¹, . . . , A^{L} one by one and updates a separation signal Y according to updating of the separation matrix W.

7. The signal processing device according to claim 6,
wherein d=2 is satisfied.
